(19) United States
(12) Patent Application Publication
(10) Pub. No.: US 2009/0049307 A1
(43) Pub. Date: Feb. 19, 2009

(54) System and Method for Providing a Multifunction Computer Security USB Token Device

(75) Inventor: Paul Ya-Chi Lin, Fremont, CA (US)

Correspondence Address: Stevens Law Group, 1754 Technology Drive, Suite #226, San Jose, CA, 95110, US

(73) Assignee: Authennex, Inc., Hayward, CA (US)

(21) Appl. No.: 11/838,132

(22) Filed: Aug. 13, 2007

(51) Int. Cl. H04K 1/00

(52) U.S. Cl. 713/185

(57) ABSTRACT

The invention discloses a small token device, ideally about the size of a key, which can plug into the USB interface of a host computer, which need not be fully trusted, and handle a variety of different security functions. The device is capable of serving as a secure USB hub, and thus can function on a host computer that only has one available USB port. Among the multiple functions that the device can perform include communicating through the internet in a secure manner, storing data in a secure manner, and access secure information through public key (PKI) methods. The invention also allows secure USB peripherals to maintain security while being hooked up to either a non-secure host computer or other non-secure USB peripherals.

### BACKGROUND

### FIELD OF THE INVENTION

The invention relates to data security and authentication methods and systems involving various trusted and non-trusted computer devices connected using the Universal Serial Bus (USB) protocol.

Introduction:

Data security has become a critical issue in the modern world. As computer technology has proliferated, so too have numerous types of security attack methods, including viruses and spyware, hardware data interception methods such as keystroke loggers, data packet interception methods, and the like. As a result, the problem of unauthorized personnel access to sensitive data has become quite large.

At the same time, while the problem of computer security breaches has become quite large, the tolerance for security breaches has become quite small. Many government regulations, such as the Health Insurance Portability and Accountability Act (HIPAA), the Federal Information Security Management Act (FISMA), the California Notice of Security Breach Act, and others, mandate fairly high levels of data security.

In addition to government mandates, other considerations, such as military or national security use, or a simple desire to avoid giving sensitive business information to competitors, also create a high need for computer security.

Although, in an ideal world, all users would have complete assurance that the computers they are using are secure, in practice this doesn't happen. Many people need computer access while traveling, and must work with either public access computers or portable laptop computers. Unfortunately, it takes a skilled hacker only a few seconds to convert an unattended secure computer into an insecure computer. Additionally, unless access to the Internet is severely restricted, the possibility of computer trojans, worms, viruses and the like getting through firewalls and infecting any given computer is relatively high.

As a result, it is often foolish to assume that any given computer can truly qualify as a fully trusted device.

A second problem is that modern computers are highly modular devices, usually consisting of multiple external peripheral devices, such as modems, printers, keyboards, disk drives, radio transceivers, and the like all connected by a simple plug-and-play interfaces, such as the USB (universal serial bus) interface.

The USB interface is widely used in modern computers. Designed for plug and play simplicity, and utilizing robust easily manipulated connectors, the USB interface allows up to 127 devices to connect to a host computer, obtain power from the host computer, and exchange data in a bidirectional manner at high data rates. The original USB 1.1 standard had a slow-speed mode of 1.5 megabits per second (1.5 Mbit/s), and a maximum data rate of 12 megabits per second. This maximum rate was later raised to 480 Mbit/s with the advent of USB 2.0.

In addition to sending data, the USB standard also allows for up to 500 milliamps (500 mA) of 5 V power per port. This power is allocated in units of 100 mA, and a compliant USB device will typically establish a connection with a port using 100 mA power, and then requires additional current up to 500 mA from the USB host.

The USB standard is designed for easy automatic connectivity. Usually host computers have a limited number of USB ports, typically 1-4, and often only 1. To overcome this problem, the USB standard allows for multiple USB devices to be connected to a single USB port on a host computer by way of a USB hub.

Although ubiquitous (estimates are that over 1 billion USB devices are in use as of 2007), the USB standard has one weakness. It was designed in a different era, when all devices were assumed to be “high trust” devices. In fact, this isn't always the case. Some USB devices are “dual use” devices, and can be used to abuse computer security.

As an example, miniature USB keystroke loggers exist, such as the KeyGhost USB Keylogger, produced by KeyGhost corporation, Christchurch New Zealand, can be placed inconspicuously at the junction between a first trusted USB device (such as a keyboard) and a second trusted USB device (such as a host computer), and in a few seconds can start recording all USB traffic between the two devices. If the first device is a USB keyboard and the second device is a computer sending sensitive information, the security consequences can be quite severe.

Consider the problems of anyone who needs to exchange sensitive information over the Internet using a computer. The computer could have been tampered with. Data packets between the computer and the Internet can also potentially be intercepted. How is data security and compliance with security regulations possible?

In order to cope with this problem, companies such as Authenex Inc., Hayward, Calif. have introduced a number of convenient miniature computer security token devices to ensure data security. These devices, which are about the size of a standard key, and which in fact can often be put on a keychain for convenient handling, can perform various computer security functions. The Authenex A-Key 3200, for example, is a small token that provides public key (PKI) encryption by providing on-board 1024/2048-bit RSA key pair generation and X.509 digital certificates. It also performs symmetric key cryptography using AES 128-bit and 256 bit, DES, 3×DES, DES-X, MD5, RC2 functions, as well as SHA-1 secure hashing algorithms. It exchanges keys by plugging into a computer via a USB port, and allows users, assuming the computer itself is secure, to insure that third parties that intercept the data will not be able to interpret it.

Authenex also produces other security tokens, such as the A-Key 4000 token, which allows users to store up to 1 gigabyte of data in a password encrypted manner using a second key sized USB token or dongle. A number of other A-Key USB security devices are also in development.

Unfortunately, due to the magnitude of the security problem, often one type of computer security method is not enough. Often multiple methods must be used. If each method uses up a different computer USB port, a problem occurs that some computers will rapidly run out of available USB ports. A second problem is that although users are usually willing to carry one security device with them at all times as a computer key-fob, users will be less willing to carry a handful of security devices with them. Ideally, what is needed is a small key-sized device that can perform multiple security functions at the same time, without using up a large number of different computer USB ports.

### SUMMARY OF THE INVENTION

The invention discloses a small token device, ideally about the size of a key that can plug into the USB interface of a host computer, that need not be fully trusted, and that can handle a variety of different security functions. The device is capable of serving as a secure USB hub, and thus can function on a host computer that only has one available USB port. Among the multiple functions that the device can perform include communicating through the internet in a secure manner, storing data in a secure manner, and transmitting secure information through public key (PKI) methods. The invention also allows secure USB peripherals to maintain their security while being hooked up to either an insecure host computer, or other insecure USB peripherals.

### BRIEF DESCRIPTION OF THE DRAWINGS

FIG. 1 shows a drawing of a token device of the invention.

FIG. 2 shows a schematic drawing of a prior art USB hub device.

FIG. 3 shows a schematic drawing of the invention's encrypted USB hub device.

FIG. 4 shows a schematic drawing of the encryption engine previously shown in FIG. 3.

FIG. 5 shows an alternative embodiment of the invention.

FIG. 6 shows a drawing of a token device of the invention. The device is capable of performing multiple security operations, while using only one USB port on a host computer.

### DETAILED DESCRIPTION OF THE INVENTION

The contents of US patent application disclosures 2003/0081774, 2004/0181673, 2004/0064740, 2004/0064706, 2005/0015588, 2005/0033995, 2006/0004974, 2006/0075486, and U.S. Pat. Nos. 7,191,344 and 7,231,526 are incorporated herein by reference.

USB hubs come in two general types—bus powered and self powered. Bus powered USB hubs obtain all of their power (500 mA) from the host computer USB interface. Since the hub itself uses power (typically under 100 mA), this means that a bus-powered USB hub will have only 400 mA of power available to deliver to its various peripherals. Assuming that it is a 4 port hub, this will be only 100 mA per port.

A self-powered hub obtains additional power from outside means, usually from an external power jack or battery. A self-powered hub can provide up to 500 mA for each one of its ports.

The USB standard is designed to be backwards compatible, and thus a USB hub must be able to cope with at least three different speeds: 1.5, 12, and 480 Mbits/sec. In order to allow a variety of different USB devices to pool their data and communicate over a single USB line, USB hubs use transaction translator (TT) chips. These transaction translators handle the translation between the different data exchange protocols used for the different USB devices.

A very large number of different USB hubs have been devised. Some are large, some are small. Some combine different types of functionality into the hub. For example, the “Yego” USB hub, produced by Ridata corporation, is a small two-port, bus-powered hub that also has flash memory. Ultra Corporation produces an “all-in-one” card reader and 6-porb USB hub that can read various types of plug in memory cards, such as memory sticks, smart media cards, secure digital cards. Cyber acoustics produces a combination 2-piece speaker set and USB port hub. Other combination devices include combination webcam USB hubs, combination Voice over IP (VoIP/USB hubs, iPod synchronization USB hubs, and so on.

All prior art USB hubs, however, have been designed for function in a “high trust” environment. That is, they are designed to pass data from one USB device to another USB device, and assume that all USB devices in the chain of devices between a sender and receiver of data are “trusted”.

Here, the invention differs from prior USB hub art, in that it is a “low trust” USB hub. This hub is designed with multiple embedded USB data security peripherals that do not assume that any other USB device in the system can necessarily be trusted. The invention essentially acts as a comprehensive multiple function security “Swiss army knife”. The device enables a user to convert almost any computer, be it public access computer, a security compromised laptop computer, or a virus infested computer into an adequate vehicle for conveying secure information.

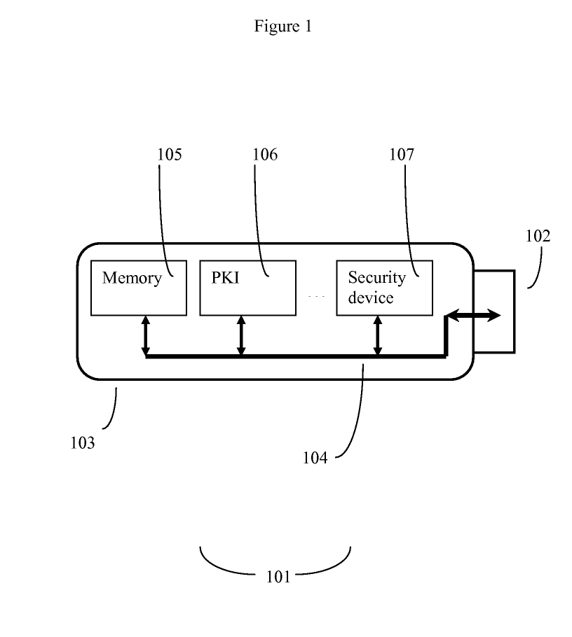

FIG. 1 shows an example of the device configured according to the invention, here embodied in a convenient key sized USB token device (101). The size is not limiting to the invention, but could have approximate dimensions of 2½″ long×¾″ wide×¼″ deep. The device contains a USB “A” connector (102) designed to connect to the USB port of a host computer, and a main body (103) that contains the device's circuit board. This circuit board is usually encased in a plastic or metal shell. This shell is ideally designed to be difficult to breach without causing obvious damage to the shell and the contents.

The device contains its own USB “hub port” (104) which allow a number of embedded USB security peripherals (105), (106), (107) to connect to the USB connector (102).

These embedded USB security peripherals are generally hardwired to the USB hub, and are generally not designed to be easily removed, but rather will normally be considered to form part of an overall unitized security device. Such embedded USB security peripherals are said to be fixedly connected to the USB hub.

In this example, one of the device's internal USB hub ports may be taken up by encrypted flash or other type of memory (105). This memory may be used to store user data, such as described in US patent application 2006/004974 for example; or alternatively run user programs such as described in US application 2006/0075486 for example. Typically the device will be capable of storing at least enough information to hold one or more sensitive documents. This memory may run from about one megabyte up to gigabytes or more, and preferably can hold at least one gigabyte or more worth of data.

Another one of the device's internal USB hub ports may be used for PKI secure access to data, following the teaching of US patent applications 2005/0064706, 2005/0015588, 2004/0064740, 2003/0081774. Alternatively this may provide pass codes to help validate network sessions, such as those described in U.S. Pat. No. 7,231,526 for example. Other embedded USB security devices (107) may also be connected to the internal USB hub.

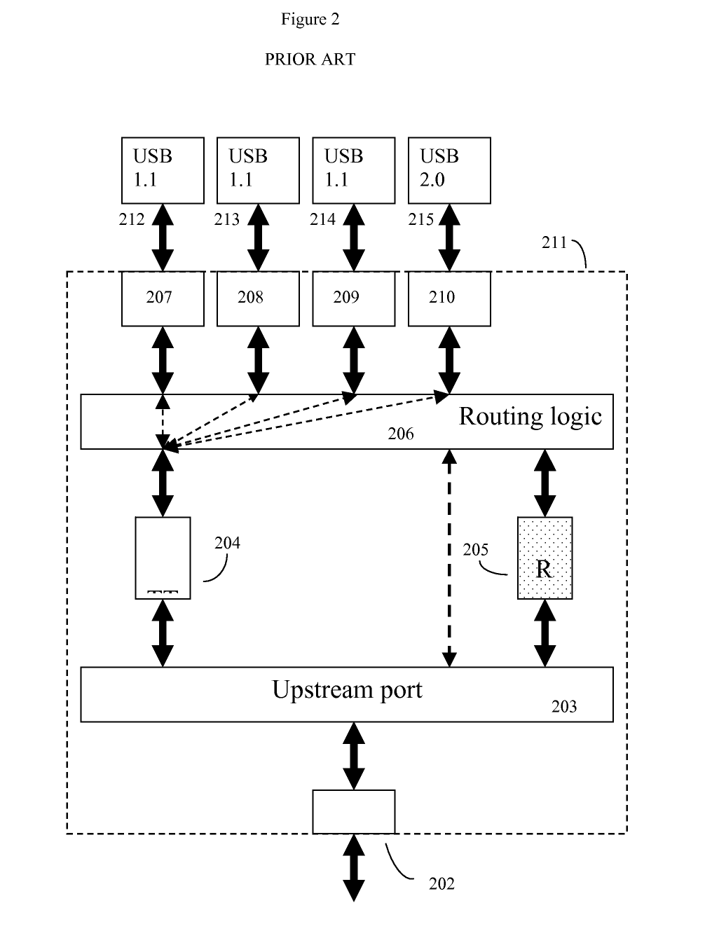

FIG. 2 shows an example of a prior art USB hub. Here, a low-cost, low-capability USB hub capable of accommodating either USB 1.1 or 2.0 peripherals is shown. The hub (201) connects to a USB connector (here assumed to be a USB 2.0 connector) on a host computer via a USB connector (202). Usually for higher performance, 4 transaction translators (one for each port) are used (not shown), as this produces faster throughput with fewer bottlenecks.

The data travels to and from the host PC through an upstream port (203), then through one or more transaction translators (204) to translate USB 1.1 data packets to USB 2.0 format. Alternatively, data can be routed directly through a repeater (205) for USB 2.0 devices. The data then travels through a routing logic stage (206), which assigns the right data streams to the right hub ports, and then out to the USB connectors to the external USB devices (207, 208, 209, 210). Usually the USB port circuitry will be covered by a metal or plastic case (211), and the USB connectors will be attached to this case. The USB port will also control power routing (not shown). External USB devices (212, 213, 214, 215), which may be various combinations of 1.5, 12, and 480 Mbit/s USB 1.1 and 2.0 devices, attach to connectors (207, 208, 209, 210).

In many cases, prior art USB hubs simplified the electronics design by using single chip USB hubs, such as the Cypress Semiconductor CY4602 reference USB 4-Port hub, design (based on the CY7C65640-LFC chip), from Cypress Semiconductor Corporation, San Jose, Calif., or other vendors. These types of chips combine 4 transaction translators, as well as other control logic such as serial interface engines, hub repeaters, routing logic, upstream ports, and the like, into a single-chip low-cost solution that makes USB hubs little more than circuit boards with connectors for the various USB ports, the chip, a case, and a small amount of supporting circuitry.

As previously discussed, the prior art USB hub design assumes a large amount of trust. That is, all USB ports connected up to the hub, either on the host computer upstream port side, or the multiple USB hub ports on the downstream side, are assumed to be “trusted” devices that will handle the data flowing through them in a responsible manner, without routing the data to possible third parties that might desire inappropriate access to the data. If any of the USB devices hooking up to the hub is not “trusted”, then this open scheme may become inadequate from the standpoint of data protection.

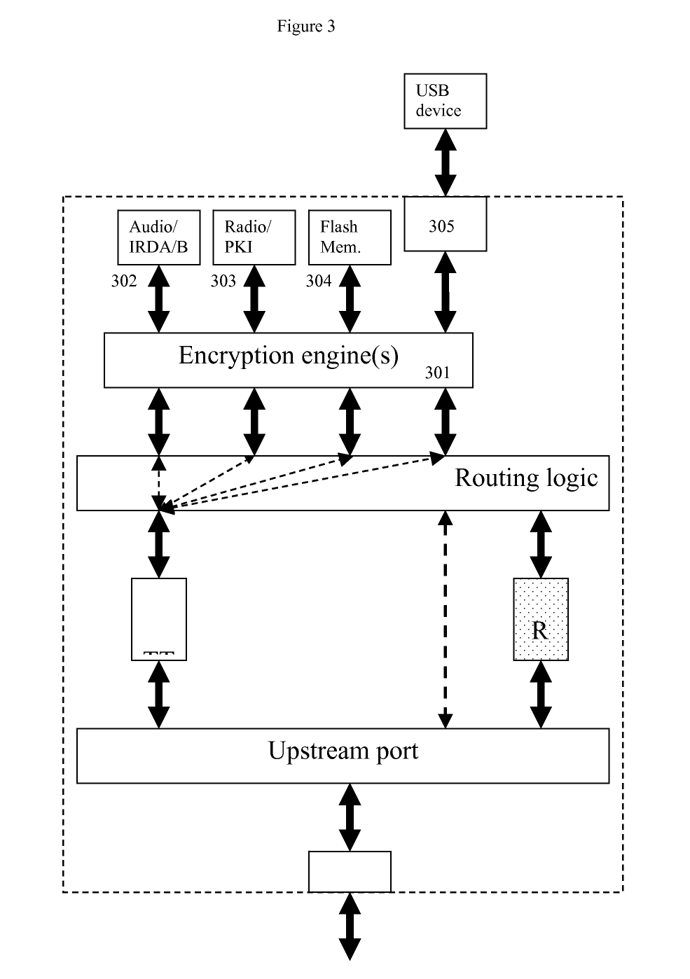

FIG. 3 shows an example of the USB hub of the invention. It differs from the prior art USB hubs in several areas. The most important change is the addition of one or more encryption engine(s) (301) to the basic USB hub design. As the name implies, the encryption engine(s) are responsible for examining the USB information packets traveling through the hub, and encrypting portions of these information packets according to predefined protocols and encryption algorithms.

At the highest level, USB information packets consist of:
A token packet (the header packet)
An optional data packet (containing the actual data payload)
A status packet (with transaction acknowledgement and error correction fields).

Normally the encryption engine will operate on the data packet (data payload) portion of the USB packet, which can be 8 to 1024 bytes long depending upon which USB speed (1.5, 12 or 480 Mbit/s) is chosen. The address and control packets will normally not be encrypted by the encryption engine, because this would interfere with the proper function of the USB hub and the associated USB devices.

The format of the data packet (data payload) part of the USB information packet will itself vary according to the specific USB device that is hooked up to the particular port hub. Each data packet going to each different USB device will itself be composed of different sub fields, some of which are control sub-fields (that is, information that tells the device where the data is going to go and how it is going to be used) and the data sub-payload, which is that fraction of the USB data packet that in turn contains data useful to the particular USB device.

Encrypting USB packets would not normally be either feasible or useful for prior art USB hubs. These hubs were designed on the assumption that any hub port could be occupied by any USB device. These hubs would function adequately if data encryption were added at the hub level. This is because each different USB device normally has many control signals encoded in the “data payload” portion of the USB information packet. As a result, applying an encryption protocol that encrypts the entire “data payload” field would likely destroy the USB device control data, causing most USB devices that plug in to the hub to malfunction.

In order to do encryption properly at the USB hub level, the encryption protocol must understand what portions of the “data payload” portion of the USB information packet can be safely altered (encrypted), and which can't. Since this will vary from USB device to USB device, the hub encryption system must be sophisticated enough to recognize this fact, and alter the bits in the “data payload” that it encrypts according to the specific USB device that is hooked up to the hub.

Here, one important simplification over prior art USB hubs can be made. In contrast to a prior-art USB hub, which must assume that any port can be occupied by any USB device, using any type of control signals embedded in the USB information packet data payload, generally most of the USB ports of the invention will be occupied with known (fixed) USB devices. These fixed USB devices will usually be located inside the same case as the rest of the invention USB hub. As a result, the protocols of these fixed or limited USB devices will generally be known in advance.

Typically, only a few (if any) ports in the invention will be external USB hub ports. A second important simplification can be made by dropping the requirement that any type of external USB device may plug into this external USB port. When external USB devices are to be used, these external devices will generally not be any type of USB device, but rather limited to certain specific types of USB device, where the structure of the USB information packets to the allowed external USB device will generally have been analyzed in advance, and suitable encryption algorithms previously determined.

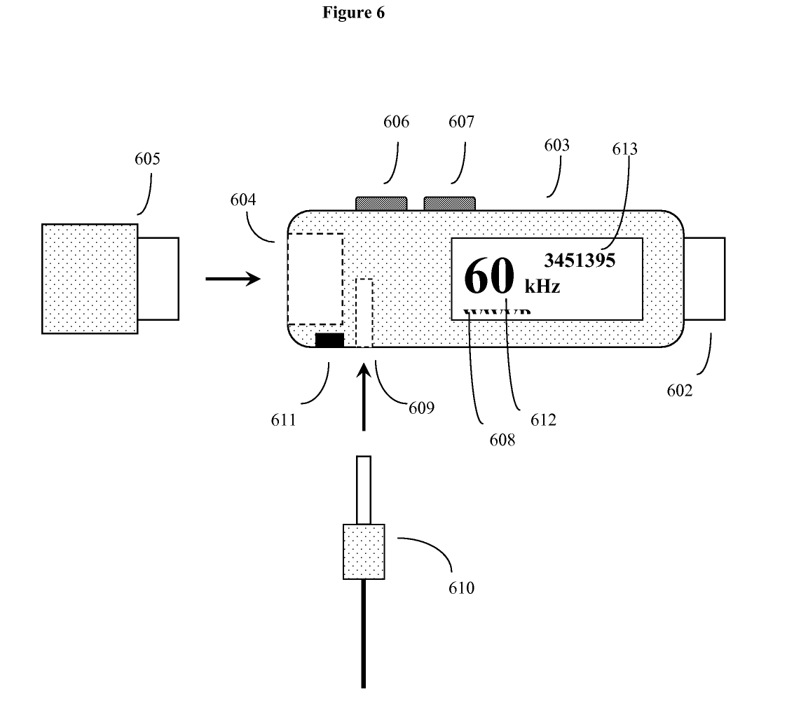

The invention device does not necessarily have to refuse to function as a USB hub if an unfamiliar USB device is attached to the external USB port. Rather (depending on the security algorithms programmed into the device), the secure USB port of the invention may simply fall back to a non-encrypted mode, and pass signals from unrecognized USB devices through without any attempts at encryption. Here the device might optionally give a warning message on its display that it is running in “pass-through” unencrypted mode. When recognized USB devices are attached to the hub, the invention device may either automatically shift to encrypted mode, or alternatively invite the user to choose which mode (encrypted, non-encrypted) to operate in, possibly by using button input from buttons on a device (FIG. 6 (606), 6(607)), or by other means.

FIG. 3 shows an example secure USB hub device with three internal “fixed” USB peripheral devices hooked up to the USB hub. In this example the one of the “fixed USB peripheral devices” is (302) an audio A/D converter for driving an audio headset for secure communications or (alternatively) an infrared (IRDA) transceiver for secure communications with a PDA or (alternatively) a cell phone or a low-power and short range Bluetooth transceiver for secure audio communications through a Bluetooth headset, keyboard, or other device.

If the fixed USB peripheral device is an audio A/D converter capable of reading audio signals from a microphone, then in one embodiment of the invention, the encryption processor may be designed to read the audio signals, identify if the audio signal corresponds to the voice from an authorized individual, and if so activate the device or modify the state of the device's encryption algorithms accordingly. Another one of the “Fixed” USB peripheral devices (303) can be a radio receiver for receiving radio signals useful for determining encryption protocols for other USB devices, following the teaching of US patent application 2005/0033995. Alternatively or concurrently, fixed device (303) may display information useful for PKI secure access to data, following the teaching of US patent applications 2005/0064706, 2005/0015588, 2004/0064740, 2003/0081774. Alternatively this may be used to help validate network sessions, following the teaching of U.S. Pat. No. 7,231,526.

When used in a PKI exchange function, the device may perform a method for exchanging dynamic encryption keys. Many different such methods exist, but the invention is unique in that it can perform such methods with a single device. One such method may include all or some of these steps, though the invention is not limited to any particular method: (a) coupling a token device to an originator computer and coupling another token device to a recipient computer, coupling the originator computer and recipient computer a network; (b) transmitting a challenge generated by the originator computer to the token device coupled to the originator computer; (c) generating a puzzle key responsive to receipt of the challenge; (d) generating a dynamic file key based upon the puzzle key and input code; (e) encrypting a data file with the dynamic file key; (t) appending decryption information to the encrypted data file; (g) appending key exchange information to the encrypted data file to generate a key exchange package; (h) transmitting the key exchange package to the recipient computer; (i) decomposing the key exchange package to obtain the key exchange information; g) transmitting the key exchange information to a server; (k) generating a key exchange challenge responsive to receipt of the key exchange information by the server; (1) transmitting the key exchange challenge to the token device coupled to recipient computer and generating an encryption key; (m) generating an encrypted dynamic file key based upon the dynamic file key and encryption key; (n) transmitting the encrypted dynamic file key to the token device coupled to the recipient computer; and (o) generating the dynamic file key based upon the key exchange challenge and the encrypted dynamic file key.

When (303) is used to generate secure passwords, the display portion of a device (FIG. 6 (608)) can display alphanumeric characters representative of one-time password data generated by the processor (613). The device's USB interface (FIG. 6 (602)) can allow the device to interface with the host computer, load password data into memory, and generate a one-time password. This can be used to help the computer log on to a secure computer over a network.

“Fixed” device (304) can be flash memory or other type of memory (such as battery backed up volatile RAM, which would lose its contents if the case was opened, and thus would be highly secure). This can be used to store user data following the teaching of US patent application 2006/004974, or alternatively can be used to run user programs such as described in US application 2006/0075486 for example.

When used to run programs from secure memory, device (304) may function to perform a method for installing and running an application stored on a token device, the method may include some or all of these steps, though the invention is not limited to any particular method: (a) coupling a token device to a host device to activate the token device; (b) retrieving an encryption application from a memory of the token device; (c) invoking an installer from the memory of the token device to configure the selected application to run on the host device; and (d) running the selected application on the host device.

This example also shows an optional external USB hub port (305). This external USB hub port may be used to drive a limited number of previously analyzed and cleared USB devices. These previously analyzed and cleared USB devices may include USB data storage devices such as external drives or optical disks, wherein case the data to and from the data storage device may be encrypted following the methods of U.S. Pat. No. 7,191,344. Other useful external USB devices that may be used with external USB hub port (305) include keyboards, display devices, PDA's, and printers.

Another USB peripheral that may be fixedly connected to a USB hub port according to one embodiment of the invention may be used to control access to computer networks. As used herein, fixedly may also include a device that is physically or electronically connected. It may be hard wired, soldered, or otherwise connected, substantially permanent connection, or other connection, but typical devices are specifically designed for removable operation. It may be removeably connected where a plug or other connection can be reused, or may include any other connection wherein a USB device may communicate with a computer. Here, the internal USB peripheral can function as part of a system for securing information obtained over a network. Such a system may include a token device adapted to be coupled to the computer. The token device typically includes a processor and a memory, where the processor adapted to run a data encryption/decryption algorithm. The memory can be used for storing shared symmetric keys that eliminate a need for key exchanges between parties in a secure network session. If a client requests access to a server, then a query is sent to the server. A challenge is then generated and transmitted to the token. The challenge can include a challenge puzzle, an encryption/decryption key ID, and a session ID code that determine which two particular symmetric shared keys are sent to the processor in the token device responsive to the query. The token performs a first round of encryption to produce an encrypted puzzle key from the two symmetric shared keys and performing a second round of encryption to generate a one-time password (OTP) from the encrypted puzzle key and the session ID code. The one-time password is transmitted to the server to compare the one-time password to a server-generated response to determine if the one-time password and the server-generated response match. If the one-time password and the server-generated response match, then the client is granted access to the network. If the one-time password and the server-generated response do not match, then the client is denied access to the network.

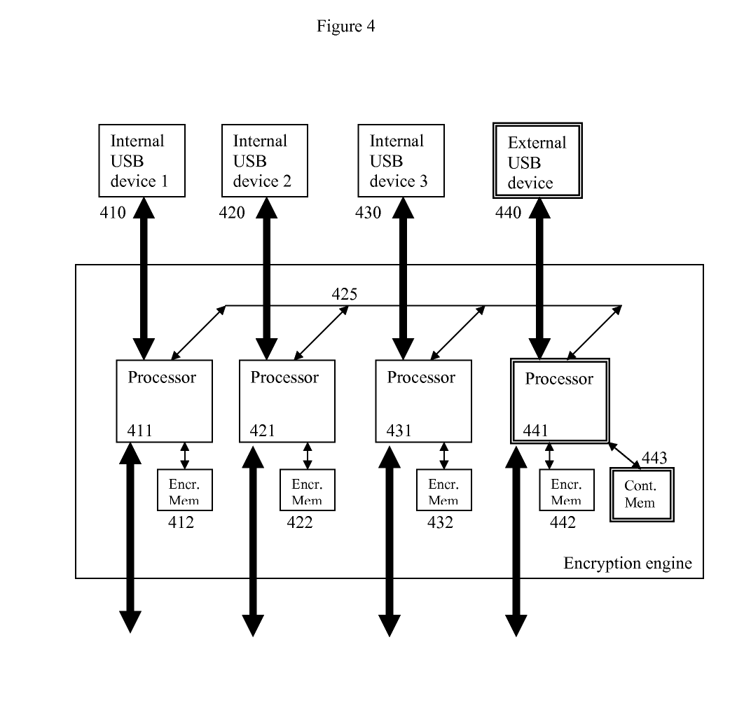

FIG. 4 shows one embodiment of the encryption engine previously shown in FIG. 3. In this embodiment, the encryption engine consists of one or more microprocessors. Each microprocessor may have an “encryption memory” that stores the encryption algorithm(s) used for the particular USB peripheral device that is hooked up to microprocessor's USB port. Often one microprocessor will be used per USB port, but depending upon the capability of the microprocessor and the computing loads put on it, one processor may drive several USB ports, or for high load activities, multiple processors may drive one USB port.

One advantage of using at least one processor per USB port is that the processor can often perform two functions at once—encrypt data to and from the specific USB device that is hooked up to the port, and optionally also run the specific USB device. Thus for low-cost devices, it may be possible to have a processor on the encryption engine both encrypt /decrypt data and also run the USB peripheral at the same time.

Thus in FIG. 4, if internal USB device 1 (410) is an audio analog to digital unit used to drive a headset, then USB device 1 can be driven by encryption engine processor 1 (411) using a first audio encryption algorithm located in encryption memory (412). If internal USB device 2 (420) is a radio receiver, signals from the receiver can be either encrypted or decrypted by encryption engine processor (421) using a radio receiver encryption algorithm located in encryption memory 422.

The radio receiver may be used in a method for utilizing publicly broadcast information as a synchronization source for shared secret purposes. The receiver may include one or more of the following operations: publicly broadcasting information; providing a token device capable of receiving publicly broadcast information and capable of generating responses based on the publicly broadcast information; generating responses based on the publicly broadcast information; providing a server capable of receiving publicly broadcast information and capable of generating challenges based on the publicly broadcast information; transmitting responses to the server; generating challenges based on the publicly broadcast information; comparing responses to challenges for verifying the responses to authenticate the token device.

Often, the radio receiver data will be useful in providing coefficients to the other processors in the encryption engine that will help the other processors decide which encryption or decryption algorithm is appropriate for use. To facilitate this exchange of encryption coefficients, it will often be useful to allow the various processors in the encryption engine to exchange at least a limited amount of data (pertaining to the coefficients of the encryption algorithms desired) to communicate via a secure channel. This secure channel is shown as the network of arrows in (425). Thus, for example, if the USB radio device (420) picks up a signal that directs all of the encryption processors to change encryption coefficients, this information can be communicated via secure channel (425) from processor (421) to the other encryption processors (411), (431), (441) in the encryption engine.

As previously discussed in commonly owned US patent application, 2005/0033995 incorporated herein by reference, numerous types of radio signals can be used for encryption purposes. These include radio clock information, global positioning system information, atomic clock information, Greenwich Mean Time information, and Loran information.

Using this receiver, the present device may perform as a system that utilizes information in publicly broadcast information as a synchronization source for shared secret purposes comprising. It does this by using the receiver (420) in the token device to receive publicly broadcast information, and then generate responses based on this publicly broadcast information. These responses can then be sent to a server that is capable of also receiving this publicly broadcast information, as well as receiving responses from the token device. The server can then generate challenges based on the publicly broadcast information, and verify the responses from the token device (the invention) to authenticate the token.

In this example, internal USB device 3 (430) is a memory cache, such as flash memory or battery backed up RAM, that stores user data in an encrypted manner. Here data to and from memory (430) is encrypted and decrypted by processor (431) using algorithms stored in encryption memory (431).

When used for data storage, the device may function as a portable memory device configured to prevent unauthorized access to data stored thereon. Such a device may include a housing containing a processor for processing data and a memory for storing data (typically solid state memory such as flash memory), and an interface for coupling the memory device to a host device, such as a computer. The processor may be coupled to or otherwise communicate with the interface for sensing if the memory device is coupled to or communicating with a host device. If the memory device is coupled to a host device, then the processor runs a program that displays information on the host device. The program may generate a graphical user interface requesting authentication information, such as a username, a password, and/or a personal identification number from the host device. If the authentication information from the host device matches authentication information stored in memory, then access to data stored in memory is granted. If the authentication information from the host device does not match authentication information stored in memory, then access to data stored in memory is denied.

In this example, the unit has an empty USB port that can be occupied by an external USB device (440), which may be more than one type of external USB device. In order to cope with the fact that the type of encryption must vary according to the type of USB device that is hooked up to port (440), processor (441) may be chosen to be a higher capability processor, capable of handing increased encryption loads. In addition to standard encryption memory (442), processor (441) may also make use of an additional control memory (443). Control memory (443) will usually contain USB device specific encryption information. Control memory (443) can either contain a list of approved USB devices, and select the appropriate memory to use when the correct approved USB devices is detected by processor (441). Alternatively the correct USB device specific algorithms can be downloaded into control memory (443) when the correct USB device is detected. These algorithms can either be obtained from the host PC, or alternatively downloaded from the memory of internal USB device 3 (443) if USB device 3 is a memory storage device.

In order to perform properly, the algorithms in control memory (443) will preferably contain an internal representation of the particular external USB device (440) that is currently in operation. This internal representation should preferably be able to examine the USB data packets, read these packets to a level of detail sufficient to distinguish between USB device control signals for device (440), and USB device data signals for device (440). The control software will generally leave the control signals for USB device (440) intact, and pass only the data portions of the signal over to the encryption algorithms located in encryption memory (442). Processor (441) will then encrypt only the data portions of the packet, and then re-associate the data portions of the packet with the unaltered control portions of the data packet, and then forward the data to or from USB device (440) and the host computer.

In this way, for example, if external USB device (440) is an external hard drive, the data written to the hard drive will be encrypted, but the access information and file structure remain will remain intact, ensuring that the hard drive will perform properly.

When being used to encrypt data to an external USB device, the device may act as a computer data access system. Such a device could include a plug-in token device for a computer on a data port, and providing for filtering of data flowing between the computer's main processor. It may also include RAM memory and a data storage (the external USB drive). A token processor may be disposed within the token device, and providing for the execution of a data encryption/decryption program. It may also include a token memory included in the token device and including a non-volatile secure memory region, which may further include a unique string of information that, in combination with the data encryption/decryption program executing on the token processor, enables token to generate data unique to a particular token device. Stored on the memory may be a copy of the unique string of information that is possessed by an administrator at a remote location and that enables a boot-up of computer if token device is unavailable. A dynamic seed (Sr) may be stored or disposed within the token memory included in the token device for assisting in recovery of any encrypted data stored in the data storage. Also stored on the device may be a dynamic key (Kn), a clear file key (CFK) comprising a non-encrypted, symmetric file key used to encrypt and decrypt data stored on the data storage so as to allow user access while maintaining encrypted data on the data storage. A transmitted copy of the clear file key (CFK) that is sent to a RAM memory in the computer that exists there until the computer is powered down; thereafter, using an encryption/decryption program running on the computer processor, and the clear file key (CFK) in memory, to routinely decrypt data as it is read from hard disk storage device (to computer memory, and to routinely encrypt data as it is written from computer memory to the hard disk external USB storage device (or optical external data storage device, or other mass external USB data storage device). Token processor information may be disposed within the token device and providing for execution of a data encryption/ decryption process to generate unique data using the unique string of information.

If external USB device (440) is an external keyboard, then most of the keystrokes will be encrypted, but certain key control keystrokes, such as control-alt-delete or other system control keystrokes will remain intact. This way an external keyboard connected to external USB port (440) would be able to defeat any data loggers attached to a non-trusted host computer (such as a public access computer), but still be able to adequately control the host computer. When used in this manner, it may be advantageous to use the buttons shown in FIG. 6 (606), (607) and display (608) to be able to switch the encryption option on and off. This way, an external USB keyboard could be connected to a host computer via the device shown in FIG. 6, and establish contact with an email function or the desired website with encryption mode set to “OFF”. Once contact has been established, the encryption function can manually be switched to “ON”, and secure data then entered in an encrypted manner.

Note that there is no requirement that each USB device connected to the hub be encrypted in the same manner. In particular, external USB devices connected to external USB device port (440) will generally be less trusted than the internal USB devices (410), (420), (430), and it may be well advised to encrypt at least external USB device (440) using an entirely different algorithm than internal USB devices (410), (420), (430). This way, any attempts to deduce the encryption algorithm used for internal USB devices (410), (420), (430) by snooping and examining the encryption algorithm used in external USB device (440) will fail because the encryption scheme may be entirely different.

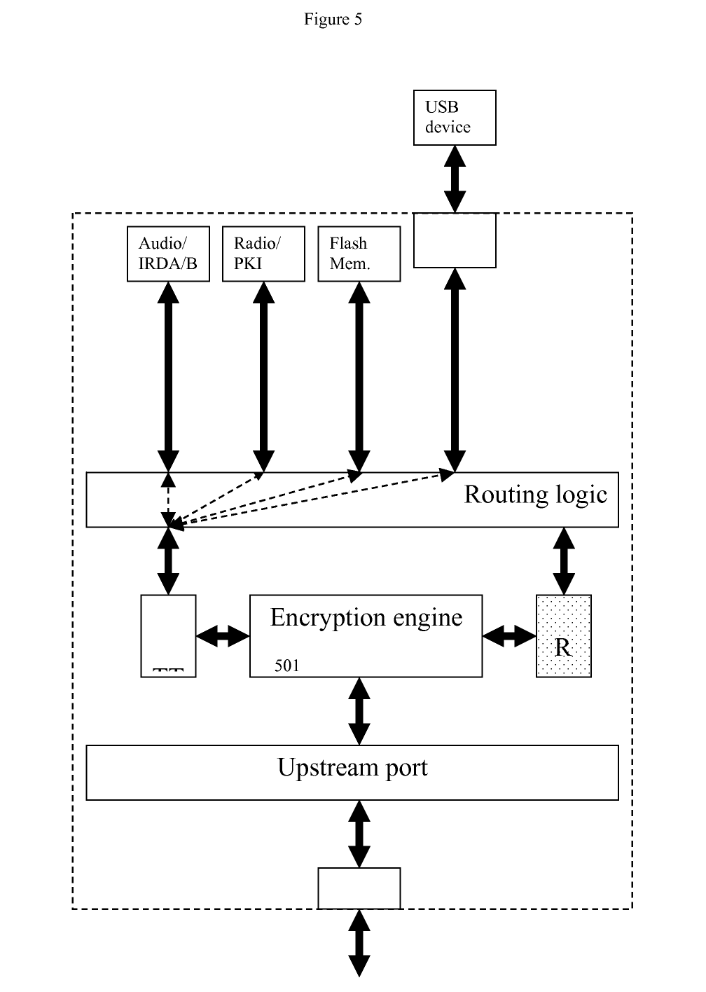

FIG. 5 shows an alternative embodiment of the invention, which may be appropriate for lower cost devices, lower speed (1.5 or 12 Mbit/s USB 1.1) devices, or lower security need devices. In this alternative embodiment, the encryption engine (501), which may be as simple as a single microprocessor and a single bank of encryption memory, operates on the USB information packets before they have been sorted to the particular USB hub port.

Because, in this alternative embodiment, the microprocessor or other processors in the encryption engine must examine the header fields (token packets) for each USB data packet, this implementation will generally either require a faster or more capable processor than the processors used in the previous implementation, alternatively will use simpler encryption methods, or alternatively will have slower peak throughput.

FIG. 6 shows a more elaborate, example of the device of the invention, here again embodied in a small key sized USB token device (601), with the same approximate dimensions of 2½″ long×¾″ wide×¼″ deep. As before, the device contains a USB “A” connector (602) designed to connect to the USB port of a host computer, and a main body (603) that contains the device's circuit board. This circuit board is usually encased in a plastic or metal shell. This shell is ideally designed to be difficult to breach without causing obvious damage to the shell and the contents.

The device also contains its own USB “hub port” (604) and can optionally function as a hub for external USB devices (605). These external USB devices could be data storage devices, such as external disk drives or optical storage drives, wherein case the data being written to and read from such devices may be encrypted following the teaching of U.S. Pat. No. 7,191,344. The device may also contain a display (606) such as a liquid crystal display (LCD), which can be used to send messages to the user.

In this example, although the device contains a four-port USB hub, three of the USB hub ports are taken up by embedded USB security peripherals that are located inside the device's case, and which are an integral part of the device. In this example, only one of the USB hub ports (604) is actually available for outside USB devices (605).

These embedded USB security peripherals are generally hardwired to the USB hub, and are generally not designed to be easily removed, but rather will normally be considered to form part of an overall unitized security device. Such embedded USB security peripherals are said to be fixedly connected to the USB hub.

In this example, as before, one of the device's internal USB hub ports may be taken up by encrypted flash or other type of memory (not shown). This memory may be used to store user data, such as described in US patent application 2006/004974 for example; or alternatively run user programs such as described in US application 2006/0075486 for example. Typically the device will be capable of storing at least enough information to hold one or more sensitive documents. As before, this memory may run from about one megabyte up to gigabytes or more, and preferably can hold at least one gigabyte or more worth of data.

In this example, another one of the device's internal USB hub ports may be taken up by a radio receiver that can be set to be tuned to one or more radio stations that produce timekeeping data or other data useful for encryption purposes. In this example, this internal USB radio is tuned by buttons (606), (607) and the station that the radio is tuned to is shown on the device's display (608), (612). In this example, the radio is tuned to the National Institutes of Standards and Technology (NIST) timekeeping radio station WWVB, that broadcasts at 60 kHz (613), and transmits ultra-precise time information, useful for synchronizing encryption devices, such as described in US patent application 2005/0033995 for example.

Buttons (606) and (607) can be used to manually adjust the frequency to other radio stations as desired, or alternatively enter other types of data into the device.

Alternatively, or simultaneously, LCD device (608) may display information useful for PKI secure access to data, following the teaching of US patent applications 2005/0064706, 2005/0015588, 2004/0064740, 2003/0081774. Alternatively this may provide pass codes to help validate network sessions, such as those described in U.S. Pat. No. 7,231,526 for example.

In some embodiments, one of the device's internal USB hub ports may be occupied by either an audio analog to digital converter and headset jack (609), designed to accommodate a headset jack (610), or an infrared data transmission IRDA port (611), or alternatively a short-range wireless transceiver such as a Bluetooth or wireless USB (WUSB) port (not shown).

Other embodiments are possible. In some cases, the device will only have a subset of the peripherals listed here, and may lack an external USB hub port, or audio, Bluetooth, or infrared (IRDA) capability. In other cases the device may lack a radio or buttons. In still other cases, the device may have supplemental means to do additional pass-code generation or data encryption functions. In this case, device display (608) can be used to display such pass codes or encryption seeds.

Other examples may be configured according to the invention. Some are described below, but it will be understood by those skilled in the art that others will be possible given this disclosure, and that the invention is not limited by such examples.

Other examples of internal USB peripheral devices that may be incorporated into the secure hub device of the invention include:

Password generation: one internal USB peripheral may function to perform a method for generating and outputting one-time passwords, the method may include all or some of the following steps and components; providing a token device, the token device including, a body portion including a processor and a memory; and a display portion, the display portion including a display for displaying alphanumeric characters representative of one-time password data generated by the processor, and an interface for coupling the token to a computer, for transmitting data between the token and computer; loading a value into the memory; feeding the value into the processor for generating data representative of one-time passwords; and generating data representative of a one-time password.

Connection to a private network: one internal USB peripheral may function to perform a method for controlling access to a private network, the method may include some or all of the following steps: (a) coupling a user device to a private network, the network including an access control server; (b) transmitting an access request from the user device to the server, the access request comprising a first response that includes a selected public shared secret and a selected private shared secret stored on the user device; (c) invoking the server to generate a second response upon receipt of the first response, the server generating the second response by means of the following steps, (i) processing the challenge transmitted to the user device to retrieve the selected public shared secret and the selected private shared secret, and (ii) processing the selected public shared secret and selected private shared secret to generate the second response; (h) comparing the first response and second response; and (i) authenticating the user device to grant access to the private network if the first response and second response match, and not authenticating the user device if the first response and second do not match.

Access control to a network: one internal USB peripheral may function to perform a method for strong access control to a network, the method may include all or some of the following steps: (a) coupling an authentication device to a network; (b) generating an access request for accessing network resources; (c) generating a challenge upon receipt of the access request; (d) generating an initial response upon receipt of the challenge; (e) generating an initial network response upon receipt of the initial response; (t) comparing the initial response and initial network response; (g) authenticating the authentication device if the initial response and initial network response match, and not authenticating the authentication device if the initial response and initial network response do not match; (h) providing limited access to network resources to the authentication device upon authentication of the authentication device; (i) transmitting a subsequent access request for accessing subsequent network resources; g) generating a subsequent network response upon receipt of the subsequent access request; (k) comparing the subsequent access request and subsequent network response; (1) authenticating the authentication device if the subsequent access request and subsequent network response match, and not authenticating the authentication device if the subsequent access request and subsequent network response do not match; and (m) providing limited access to subsequent network resources upon authentication of the authentication device.
In either of these embodiments, the various components or process steps may be rearranged or interchanged depending on a particular application, and those skilled in the art will understand that such changes can be made without departing from the spirit and scope of the invention, which is defined by the appended claims and their equivalents.
The invention may also involve a number of functions to be performed by a computer processor, such as a microprocessor. The microprocessor may be a specialized or dedicated microprocessor that is configured to perform particular tasks by executing machine-readable software code that defines the particular tasks. The microprocessor may also be configured to operate and communicate with other devices such as direct memory access modules, memory storage devices, Internet related hardware, and other devices that relate to the transmission of data in accordance with the invention. The software code may be configured using software formats such as Java, C++, XML (Extensible Mark-up Language) and other languages that may be used to define functions that relate to operations of devices required to carry out the functional operations related to the invention. The code may be written in different forms and styles, many of which are known to those skilled in the art. Different code formats, code configurations, styles and forms of software programs and other means of configuring code to define the operations of a microprocessor in accordance with the invention will not depart from the spirit and scope of the invention.

Within the different types of computers, such as computer servers, that utilize the invention, there exist different types of memory devices for storing and retrieving information while performing functions according to the invention. Cache memory devices are often included in such computers for use by the central processing unit as a convenient storage location for information that is frequently stored and retrieved. Similarly, a persistent memory is also frequently used with such computers for maintaining information that is frequently retrieved by a central processing unit, but that is not often altered within the persistent memory, unlike the cache memory. Main memory is also usually included for storing and retrieving larger amounts of information such as data and software applications configured to perform functions according to the invention when executed by the central processing unit. These memory devices may be configured as random access memory (RAM), static random access memory (SRAM), dynamic random access memory (DRAM), flash memory, and other memory storage devices that may be accessed by a central processing unit to store and retrieve information. The invention is not limited to any particular type of memory device, or any commonly used protocol for storing and retrieving information to and from these memory devices respectively.

The invention has been described herein to include a system and method for providing a convenient USB device that provides various useful features. Although this embodiment is described and illustrated in the context of particular devices, systems and related processes, the scope of the invention extends to other applications where such functions described herein are useful. Furthermore, while the foregoing description has been with reference to particular embodiments of the invention, it will be appreciated that these are only illustrative of the invention and that changes may be made to those embodiments without departing from the principles of the invention.

What is claimed is:

1. A multiple function USB token computer security device, the security device comprising:
a single USB connector configured to communicate with a host computer;
a data encryptor having at least one encryption algorithm and a processor capable of implementing the encryption algorithm;
memory capable of storing USB accessible user data in an encrypted state; and
one or more additional computer security devices configured to perform an additional security function.

2. The security device of claim 1, wherein the at least one additional security devices is selected from the group consisting of PKI key providing and reading devices, password generating devices, network access control devices, radio receiver devices, IRDA devices, audio devices, biometric measurement devices, a finger print reader, Bluetooth transceiver, and wireless USB transceiver.

3. The security device of claim 1, the device additionally containing a visual display capable of displaying images selected from the group consisting of numeric symbols, alphanumeric symbols, graphical symbols, and bit mapped symbols.

4. The security device of claim 1, wherein the device may modify its encryption algorithm based upon data received from its one or more additional computer security devices.

5. The security device of claim 1, the device additionally containing at least one manual data entry means selected from the group consisting of push buttons, pressure switches, and touch sensors, wherein the device modifies its encryption algorithm based upon data received from the manual data entry means.

6. The security device of claim 1, wherein the encryption algorithm is selected from one or more items from the group consisting of 1024/2048-bit RSA key pair generation, X.509 digital certificates, symmetric key cryptography using AES 128-bit and 256 bit, DES, 3×DES, DES-X, MD5, RC2 functions, and SHA-1 secure hashing algorithms.

7. The security device of claim 1, the device additionally containing one or more USB hub ports capable of connecting external USB peripheral devices to a host computer, the hub ports being capable of either passing USB signals through in an unencrypted manner, or capable of encrypting USB signals from at least a subset of the external USB peripheral devices.

8. The security device of claim 7, wherein the external USB devices capable of connecting to the external USB hub port on the device and being encrypted by the device are selected from the group consisting of USB keyboards, USB display devices, USB audio headsets, USB solid state memory devices, USB hard drives, USB optical drives, and USB magnetic media data storage devices.

9. A secure USB hub device, the device comprising;
at least one upstream USB ports for communicating with the host device;
a plurality of downstream USB hub ports capable of connecting to USB peripherals;
routing logic configured to determine which USB information packets are transmitted among the USB downstream hub ports; and
at least one encryption engine capable of examining the USB information packets and capable of at least one of encrypting and decrypting at least a portion of the USB packets according to at least one of a data encryption and decryption algorithm.

10. The USB hub device of claim 9, wherein at least some of the USB hub peripherals are fixedly connected to the device, and are chosen from the group consisting of memory devices, PKI key providing and reading devices, network access control devices, password generating devices, radio receiver devices, IRDA devices, audio devices, biometric measurement devices, finger print reader, Bluetooth transceiver, or wireless USB transceiver.

11. The USB hub device of claim 9, wherein the encryption engine comprises memory capable of storing at least one encryption algorithm, and at least one microprocessor, the at least one microprocessor being capable of intercepting USB information packets as they traverse the path between the host interface USB port and one or more peripheral USB ports, the at least one microprocessor being capable of reading the data payload of the USB information packets and interpreting what portions of the USB data payload may be safely encrypted and sent to the USB peripheral while allowing the USB peripheral to continue to receive unaltered basic control information needed either store, transmit, or process the USB data payload.

12. The USB hub device of claim 9, wherein the encryption algorithm used by the encryption engine varies according to data received from USB peripherals either internally or externally connected to the device, wherein the USB peripherals are selected from the group consisting of radio receiver peripherals, biometric signal monitoring peripherals, data storage peripherals, wireless radio transceiver peripherals, and IRDA transceiver peripherals.

13. The USB hub device of claim 9, wherein the device is a unitized device with a case, and at least some of the USB peripherals are fixedly connected to the USB downstream hub ports and are inside of the case or are on the surface of the case.

14. The USB hub device of claim 9, the device additionally containing a visual display capable of displaying images selected from the group consisting of numeric symbols, alphanumeric symbols, graphical symbols, and bit mapped symbols.

15. The USB hub device of claim 9, the device additionally containing at least one manual data entry means selected from the group consisting of push buttons, pressure switches, and touch sensors, wherein the device is configured to modify its encryption algorithm based upon data received from the manual data entry means.

16. The USB hub device of claim 9, wherein the encryption algorithm is selected from one or more items from the group consisting of 1024/2048-bit RSA key pair generation, X.509 digital certificates, symmetric key cryptography using AES 128-bit and 256 bit, DES, 3×DES, DES-X, MD5, RC2 functions, and SHA-1 secure hashing algorithms.

17. The USB hub device of claim 9, wherein the device has at least one external USB hub connector for connecting to at least one external USB peripheral, and wherein the encryption engine has electronic memory for receiving instructions defining the manner wherein to encrypt USB information packets going to and coming from the external USB peripheral, the instructions defining the manner wherein at least one processor in the encryption engine will determine which elements in the USB packet data payload field may be safely encrypted while allowing the USB peripheral to maintain its basic function, and the manner wherein elements in the USB packet data payload field may be safely encrypted.

18. The security device of claim 16, wherein the external USB devices capable of connecting to the external USB hub port on the device and being encrypted by the device are selected from the group consisting of USB keyboards, USB display devices, USB audio headsets, USB solid state memory devices, USB hard drives, USB optical drives, and USB magnetic media data storage devices.

19. A method for enhancing computer data security, the method comprising;
encrypting or decrypting USB information packets by the steps of,
examining the packets and determining, for at least a subset of the packets going to a specific USB device, what portion of the packets represent a USB data payload;
determining the control signals used by the specific USB device to regulate flow of data to and from specific memory locations in the specific USB device;
determining which portions of the USB data payload contain control signals to control data sent to specific memory locations in the specific USB device, and which portions of the USB data payload contain data intended for storage in the specific memory locations in the specific USB device; and
encrypting or decrypting the portions of the USB data payload that contain data intended for storage in specific memory locations of the specific USB device according to one or more encryption algorithms, and passing through the control signals to control data sent to specific memory locations in the specific USB device in an unchanged state.

20. The method of claim 19, wherein the encryption algorithms are selected from one or more items from the group consisting of 1024/2048-bit RSA key pair generation, X.509 digital certificates, symmetric key cryptography using AES 128-bit and 256 bit, DES, 3×DES, DES-X, MD5, RC2 functions, and SHA-1 secure hashing algorithms.

21. The method of claim 19, used to control multiple USB security peripheral devices connected by a USB hub to a single USB connection to a host computer.

22. The method of claim 19, wherein the specific USB devices are selected from the group consisting of radio receiver peripherals, biometric signal monitoring peripherals, data storage peripherals, wireless radio transceiver peripherals, IRDA transceiver peripherals, USB keyboards, USB display devices, USB audio headsets, USB solid state memory devices, USB hard drives, USB optical drives, and USB magnetic media data storage devices.
